(19) United States
(12) Patent Application Publication
(10) Pub. No.: US 2026/0269664 A1
(43) Pub. Date: Sep. 10, 2026

(54) HOUSING-FREE DYNAMOELECTRIC ROTARY MACHINE HAVING ADD-ON ELEMENTS

(71) Applicant: Innomotics Gmbh, 90441 Nürnberg (DE)

(72) Inventors: Klaus Büttner, Hollstadt (DE); KLAUS KIRCHNER, Ostheim (DE); MATTHIAS WARMUTH, Windshausen (DE)

(73) Assignee: Innomotics Gmbh, 90441 Nürnberg (DE)

(21) Appl. No.: 18/876,548

(22) PCT Filed: Jun. 15, 2023
(86) PCT No.: PCT/EP2023/066033

§ 371 Date: Dec. 18, 2024

(30) Foreign Application Priority Data
Jul. 13, 2022 (EP) 22184703.1

(51) Int. Cl. H02K 1/18; H02K 1/20; H02K 5/15

(52) U.S. Cl. CPC H02K 1/185; H02K 1/20; H02K 5/15

(57) ABSTRACT

A housing-free dynamoelectric rotary machine includes a stator having a substantially hollow cylindrical magnetically conductive body which includes a plurality of jaws which are distributed on an outer circumference of the magnetically conductive body and arranged in a shape of pincers such that two of the jaws in opposite relation to one another form an axially extending channel structure. A mounting element is receivable in the channel structure and moveable axially and/or about its own axis in the channel structure. A connecting element connects the mounting element to an add-on element in such a way that a complementary contact region of an outer section of the jaws and a corresponding surface of the add-on element result in at least one section to realize a wedge effect on the complementary contact region. A rotor mounted for rotation about an axis is spaced apart from the stator by an air gap.

The Invention relates to a housing-free dynamoelectric rotary machine with one or more add-on elements.

Dynamoelectric rotary machine, in particular motors in the industrial environment, are usually designed with a housing. In particular, housings made of aluminum or gray cast iron are used. The housing is placed cold or warm on a stator by means of a press fit.

The tasks of this housing include, inter alia, cooling of the dynamoelectric machine, In particular of the stator and connection facilities, such as flanges, supporting feet, etc.

The majority of industrial motors (approx. 50%) is accordingly designed as a conventional motor. These feet are generally welded, cast or screwed to the housing.

A damaged housing is often a reason to dispose of the entire dynamoelectric machine since repair is sometimes difficult.

Furthermore, a housing restricts the cooling efficiency of a dynamoelectric machine.

Therefore, there are also housing-free dynamoelectric machines.

DE 20 37 769 A1 thus discloses a surface-cooled, housing-free electric motor with bearing shields which are supported on the stator laminated core consisting of rectangular laminations, wherein the stator laminations have teeth formed on part of or on the entire outer circumference in such a way that they can be punched out of strip material in a grid-free manner.

DE 78 13 179 U1 discloses a housing-free electric machine, preferably an electric motor, with a rotor and with a laminated stator laminated core, on the two end faces of which bearing shields are arranged, wherein at least one dovetail guide which extends parallel to the longitudinal axis of the rotor shaft of the electric machine and is formed by the stator laminated core is provided on the circumference of the stator laminated core, which guide positively guides in the manner of a straight line and supports at least one member of the electric machine, which member is secured against axial displacement in its operating position.

US 2006/284511 A1 discloses a motor comprising a stator core which is formed from a plurality of stator laminations and which at least partially forms a circumferential surface of the motor. Each stator portion has a plurality of ribs extending radially outward. During assembly, the ribs of adjacent laminations together form larger ribs which extend over the length of the stator core. These laminations improve the cooling of the motor by improving the heat dissipation of the motor.

EP 3 944 465 A1 discloses a housing-free dynamoelectric rotary machine with a stator,
wherein the stator has a material layer structure, wherein the material layer structure has a plurality of material layers, wherein the material layers are lined up along an axis of rotation,
wherein the material layer structure has a plurality of thickened portions and a plurality of grooves, wherein a groove is arranged between two thickened portions,
wherein at least one groove is embodied in such a way that at least one slot wedge can be received, wherein at least one thickened portion is formed in such a way that the slot wedge can be fixed,
wherein an end element is arranged on at least one axial end of the stator, wherein the end element is connected to the stator by means of at least one connecting element, wherein at least one slot wedge is arranged in at least one groove of the stator,
wherein the connecting element is connected to at least one slot wedge.

A disadvantage of these known motors is that they are produced, inter alia, in a comparatively complex manner and have insufficient vibration behavior during operation of the dynamoelectric rotary machine.

Based on this, the object of the invention is to provide a dynamoelectric rotary machine which, with a comparatively simple construction, a high level of compactness, a high cooling efficiency, low vibration behavior and is suitable for a wide variety of applications, moreover.

The object is achieved by a housing-free dynamoelectric rotary machine with a stator and a rotor which is rotatably mounted about an axis and which is spaced apart from the stator by an air gap,
wherein the stator has a substantially hollow cylindrical magnetically conductive body,
wherein the magnetically conductive body, distributed on its outer circumference, has a plurality of jaws arranged in the shape of pincers,
wherein two jaws arranged opposite one another in the shape of pincers embody an axially extending channel structure into which at least one mounting element can be received which can be moved axially and/or about its own axis in the channel structure, wherein the mounting element can be connected to an add-on element by means of connecting elements, in particular a screw, in such a way that complementary contact regions of outer sections of the jaws and corresponding surface of the add-on elements result in sections which bring about a wedge effect on the complementary contact region.

Inventively, channel structures or prismatic geometries are created on the outer diameter of the stator—irrespective of whether one-piece magnetically conductive bodies or laminated core. The geometries can also be referred to as prismatic corresponding geometries or at least prismatic corresponding geometries in sections. Their contact regions are thus complementary at least in sections to the corresponding surfaces of the add-on elements.

In the case of individual laminations, additional prismatic geometries are punched during the production process (punching) of the laminated core which finally produce a prismatic receptacle for add-on elements, such as feet, flanges, etc., at least axially in sections, on the stacked laminated core of the stator.

In accordance with this contour, the add-on elements are equipped with a matching—i.e. complementary—reciprocal geometry for fixing.

In the prismatic receptacles of the stator, which are formed by the opposing jaws, axially extending pockets, i.e. channels, are available in the inner region into which mounting elements are inserted. These mounting elements can be moved axially and/or about their own axis in the channel, and this facilitates the insertion and alignment of the mounting elements in the channel.

Inventively, the mounting elements are round in their cross-section, in particular are circular, and have a thread turn or a plurality of thread turns, in particular aligned in pairs.

Thus, in a simple manner, each mounting element may be equipped with one or two or, in pairs, other mounting possibilities, so a wide variety of installation feet or other add-on elements can be attached, In particular, they may be screwed on.

When the add-on elements are screwed on, a reinforcing holding effect is produced between the jaws and the add-on elements.

The mounting element brings about a widening of the jaws, and this leads to a wedge effect, that is to say a tensioning on the complementary surfaces, i.e. the jaws arranged in a pincer shape and the add-on elements.

As a result of this tensioning, undesired micro-movements on the add-on elements, in particular of the foot mounting, which arise from electromagnetic or mechanical Imbalances of the housing-free dynamoelectric rotary machine, are reduced.

The omission of a mechanical interface (housing stator) also has a positive effect on the susceptibility to vibration of the overall system, i.e. the entire dynamoelectric rotary machine.

The rigidity of this mounting system is thus higher than, for example, in the case of a comparatively known foot mounting on a housing of a dynamoelectric rotary machine.

The strength values of the materials of this mounting system are preferably selected such that the deformation due to the tensioning of the components involved, such as add-on elements, mounting elements, moves in the elastic range.

Thus, a renewed assembly of the add-on elements after disassembly is also possible.

By means of the inventive mounting, the add-on elements receive an adjustable pre-tensioning which guarantees additional security against loosening of the add-on elements on the stator,

The inventive mounting of the add-on elements is thus extremely secure in the radial and in the axial directions.

End-face sharp edges, in particular of the axially and/or radially outer laminations or lamination sections, are covered by covers integrated in the bearing shield. The risk of injury on the sharp edges of the outer laminations is thus reduced. This also avoids flaking of paint (after painting) at these edges.

With the inventive mounting, add-on elements are fixed directly to the stator, i.e. without an Interface housing, with a self-reinforcing holding effect. As a result, in particular a mounting of supporting feet or flanges with considerably higher rigidity than in the mounting of supporting feet or flanges on a housing is achieved. The add-on natural frequency is higher, as a result of which reliable operation is possible in a wide frequency band and thus also for increased rotational speeds of a dynamoelectric rotary machine.

The critical vibration movements, seesawing to the side and along the length are reduced.

The function of mounting various add-on elements is integrated into the stator, as a result of which, In the case of a housing-free dynamoelectric rotary machine it is possible, despite omitting the housing, to obtain technically improved fixing.

In the case of a laminated stator, it is possible, due to the high manufacturing accuracy from the punching technique, to dispense with surface machining on the add-on elements on the entire dynamoelectric rotary machine. These surfaces can thus already be produced during machining, for example on the Individual foot. The permissible tolerance in a motor axle height (foot surface to motor axis) can be maintained by the foot and assembly tolerance, This is up to and Including a final axial height of 250 mm, a maximum tolerance of 0.5 mm, and above the axial height of 25 mm, the maximum permissible tolerance is 1 mm.

In the case of a flange motor (i.e. a dynamoelectric rotary machine without feet), the prismatic geometries serve in their shaping as cooling ribs.

Painting the inside of the jaws, i.e. the channels, is possible without problems. The tolerance in the paint layer thickness can be compensated by the mounting element since this functions in its radial position in a tolerance range of approximately 500 μm without problems.

In one embodiment, an end element, in particular a bearing shield, is arranged on at least one axial end of the stator, wherein the end element is mechanically connected to the stator by means of at least one connecting element.

The channel structure is thus closed off axially, with the end elements creating a packing of the stator and a fixing of the bearing shields.

In one embodiment, at least one mounting element is arranged in at least one channel structure of the stator.

A plurality of mounting elements in a channel structure allow a wide variety of fixings of the housing-free dynamoelectric rotary machine, for example on a base. It is possible to influence the vibration properties of the feet and/or positionings on the housing-free dynamoelectric rotary machine by way of selection.

In one embodiment, in which one, two or three mounting element(s) are present per channel, not only feet but also other add-on elements, such as converter holders, holder for a terminal box, terminal box base, holder for a monitoring apparatus or transport lugs, etc., may be attached.

In order to further improve the cooling of the housing-free dynamoelectric rotary machine, the magnetically conductive body has cooling ribs which are oriented substantially radially or in parallel at least in sections on the outer circumference of the stator.

A further cooling effect is achieved in that the add-on elements are provided with ribs at least in sections. As a result of the tensioning of the complementary surfaces—i.e. of the jaws arranged in the shape of pincers with the add-on elements, heat can thus be transferred from the laminated core to the add-on elements.

In order to further reduce the eddy currents during operation of the housing-free dynamoelectric rotary machine, the magnetically conductive body is constructed from laminations, wherein each lamination is designed in one piece and has at least grooves of a winding system and jaws arranged in the shape of pincers, wherein these laminations form a laminated core of the stator with one or more channel structure(s) in an axially layered manner.

These preferably punched laminations are firmly bonded to one another, in particular adhesively bonded and/or welded to sections or axially fixed by tie rods.

Advantageously, the individual laminations are packed together during a punching process or after punching with one another to form a stator iron core. This is achieved particularly well by adhesive bonding of the individual laminations over the entire surface.

In addition, bonding over the entire surface offers the advantage that the individual laminations are sealed with respect to one another. In this way, good protection against contact, foreign bodies and water is achieved.

The positioning of the mounting elements is facilitated if, in the case of the housing-free dynamoelectric rotary machine the end element is designed as a bearing plate and covers the axially extending channels at least in sections.

In a further embodiment, at least one end element has at least parts of a terminal box which serves to supply the dynamoelectric rotary machine with electrical energy. The variety of parts of a dynamoelectric rotary machine is thus reduced.

The cooling ribs of the stator and the cooling ribs of the end element are advantageously arranged axially in an alignment.

The stator, in particular the laminated core of the stator, is, in particular on its outer jacket surface, covered at least in sections with a coating in order to obtain protection against contact, corrosion, foreign bodies and water.

In an advantageous embodiment, the stator is provided with a coating in such a way that an impervious, smooth and thus easily cleaned surface is provided. This is particularly important in the medical sector or in the food industry.

Furthermore, the coating is suitable not only on the surface for forming an insulating layer between winding and stator lamination in an inner region of the grooves.

A metallic coating, for example, is also possible on the outer circumference. The following are conceivable: a galvanic coating, a coating by thermal flame spraying or gas dynamic cold spraying, and a coating by way of a dipping method (for example, galvanizing).

Preferably, only one type of coating is applied, which is suitable for the outer region of the stator and for internal regions. A resin-based coating which is applied, for example, by painting or dipping, is particularly suitable for this purpose. An electrostatic powder coating (for example, with a subsequent thermal treatment) represents a further possibility.

The metallic coating advantageously has a thickness of between 20 μm and 70 μm, in particular between 30 μm and 60 μm. A plastic coating has values between 60 μm and 500 μm.

Furthermore, a coating is conceivable which has paint and/or resin. These can be based on polyester (unsaturated) and/or epoxy. Silicones are also conceivable.

As a result of the coating, the stator is protected against corrosion and thus rust formation, for example. This is achieved, for example, by dipping into a rust-protection substrate and/or by painting with the rust-protection substrate.

Moreover, electrical insulation can be generated by way of the coating. This is done, for example, by fillers in the coating.

Ceramic fillers are advantageously used here to improve resistance to abrasion, preferably in the outer area. Ceramic fillers can also be used to increase the insulation capacity and heat conduction, in particular in a groove region for the winding.

Also suitable as fillers are thermally conductive particles, for example quartz sand, or partially discharge-resistant particles, in particular based on silicon.

Inventively, a conventional housing is dispensed with. Previous housing functions, such as holders for supporting feet, flanges, etc. are integrated in the stator in that these pincer-shaped jaws and/or ribs are punched into the respective individual lamination during the punching process.

The bearing shield advantageously has a receptacle for a bearing for mounting a shaft of the rotor. Advantageously, the housing-free dynamoelectric rotary machine has a bearing shield on an A side (side facing a work machine) and a bearing shield on a B-side (side facing away from a work machine). The bearing shield can have axially aligned ribs, as well as on the end faces, surface-enlarging structures, in order to obtain further cooling.

Advantageously, the bearing plate has ribs which are axially aligned with the cooling ribs of the magnetically conductive body of the stator,

Winding heads of a winding system of the stator, which are preferably positioned axially below the end element, can thus better emit their heat losses. In this way, the efficiency of the housing-free dynamoelectric rotary machine can be increased.

In an advantageous embodiment, the connecting element, which fixes the mounting elements to the jaws of the stator, is a screw element. The screw element is preferably a clamping screw in order, for example, to tension or fix a supporting foot via the mounting element to the stator. In this case, tensioning takes place, in particular, on the complementary surfaces, the jaws arranged in a pincer shape and the add-on elements.

In an advantageous embodiment, the end element has a connection box for supplying electrical energy.

The connection box advantageously has a terminal box base and is embodied for connection to a terminal box.

The invention also offers the advantage that recycling of the dynamoelectric machine is simplified since no housing is present. A winding can be removed, for example in the event of damage, from the laminated core of the stator and a new winding can be introduced. It is thus easily possible to reuse the laminated core of this stator and the components which can be attached there.

The invention also offers the advantage that machining of centering features is not required. The channel base in the stator is used for this purpose. The accuracy of a coaxiality and thus ultimately the positioning of a rotor in a stator hole is very high due to punching of the individual laminations.

The machine with different, power-related lengths of the laminated cores within an axle height can thus be designed as short as possible. A machine length, that is to say the length of the active part (laminated core of the stator with winding), is thus not dependent on a housing.

The bearing shield is not mounted on an explicit housing surface, but rather directly on the laminated core of the stator.

In this case, the bearing shields provided on both sides are preferably tensioned with screws or rivets.

The invention makes it possible to Increase an outer diameter of the stator with respect to comparable dynamoelectric machines with a housing. By means of a larger stator outer diameter, it is possible to design a rotor outer diameter so it is also larger and to thus achieve a higher power or a higher efficiency. Improved heat dissipation is thus also provided.

The invention is suitable for all fields of application of dynamoelectric rotary machines, in particular for industrial applications such as pump, fan, compressor drives and for conveyor systems. Machines of this kind may also be used in the food industry, but also in applications in traffic engineering as a traction drive or an auxiliary drive.

The invention and further advantageous embodiments of the invention will be explained in more detail with reference to the exemplary embodiments represented in principle. In the drawings:

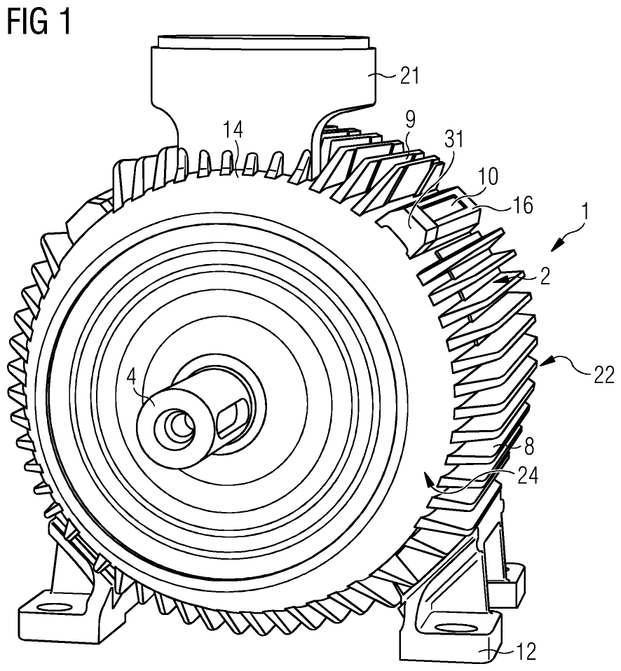

FIG. 1 shows a housing-free dynamoelectric rotary machine in a perspective representation,

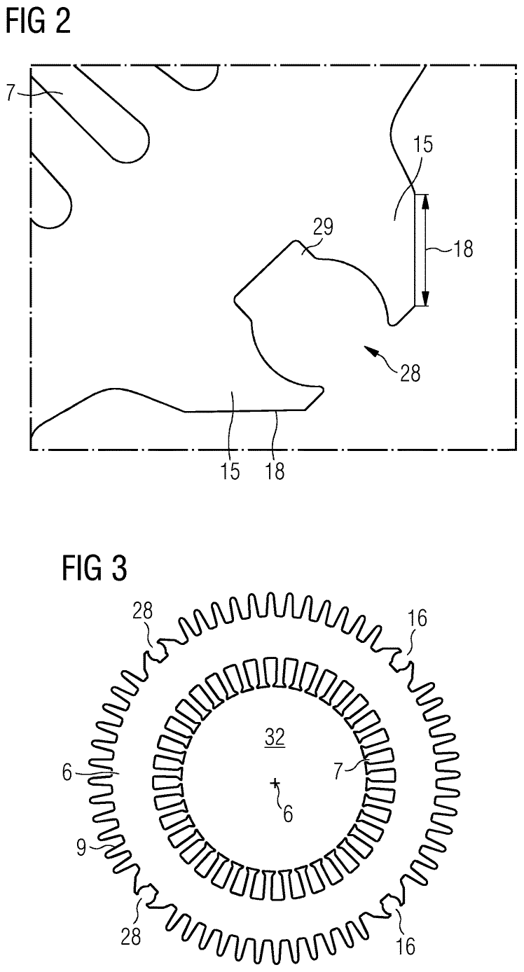

FIG. 2 shows a partial detail of a contour of a channel,

FIG. 3 shows a lamination,

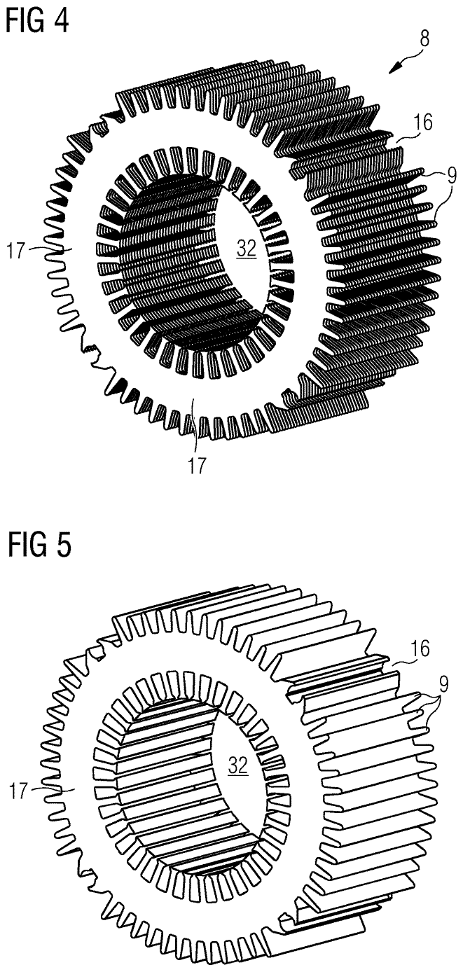

FIG. 4 shows a laminated core in a perspective representation,

FIG. 5 shows a magnetically conductive body,

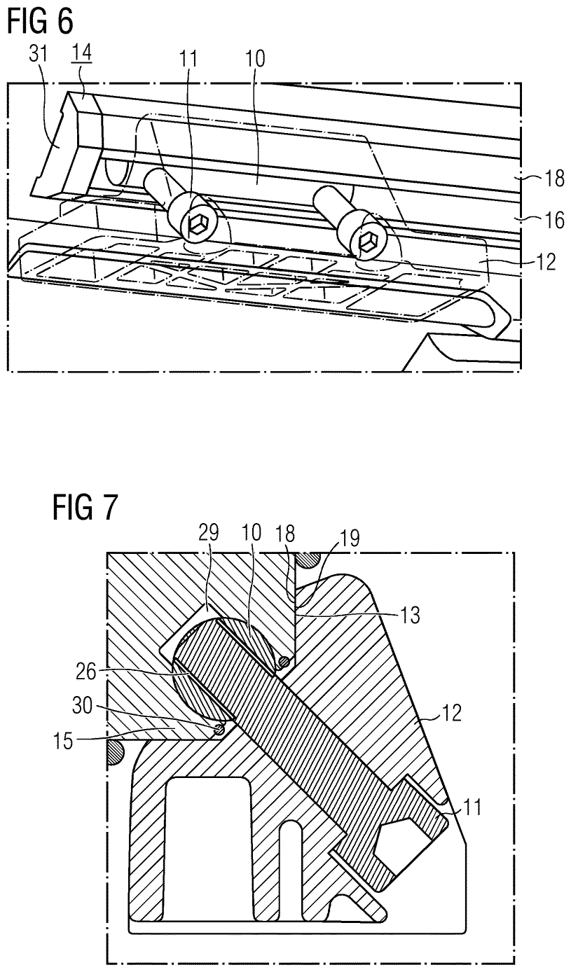

FIG. 6 shows a perspective representation of a mounting of a foot,

FIG. 7 shows a section through a mounting of a foot,

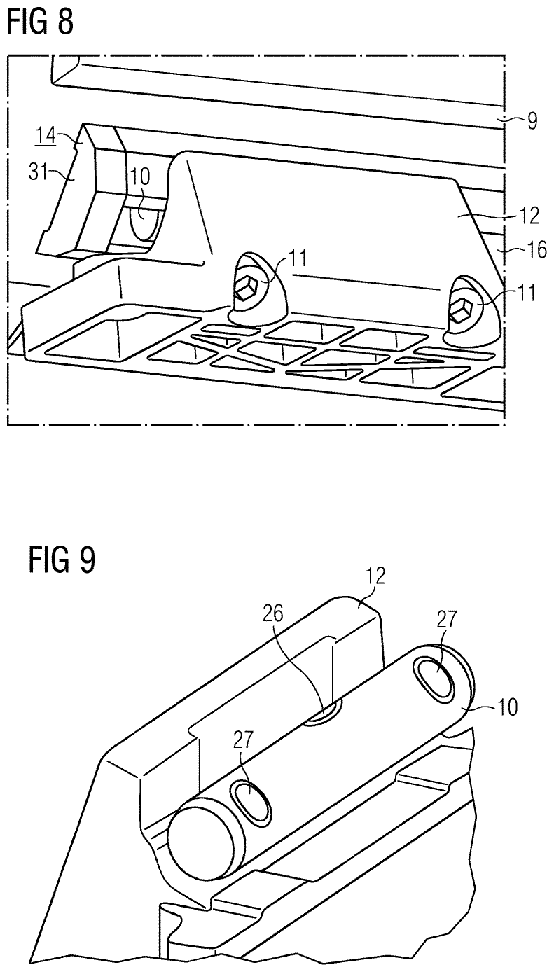

FIG. 8 shows a perspective representation of a mounting of a foot,

FIG. 9 shows a representation of a mounting element in a channel,

FIG. 10 shows a cross-section of a stator with feet, the dynamoelectric rotary machine with a hood,

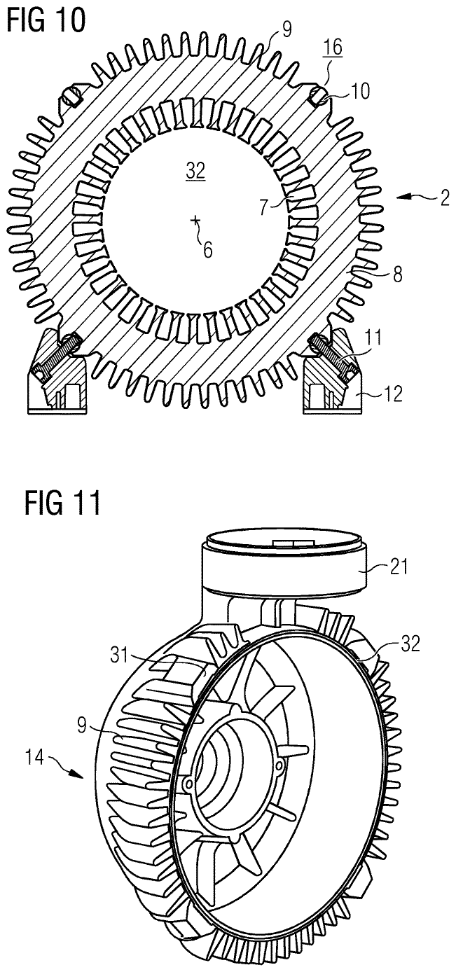

FIG. 11 shows a bearing shield,

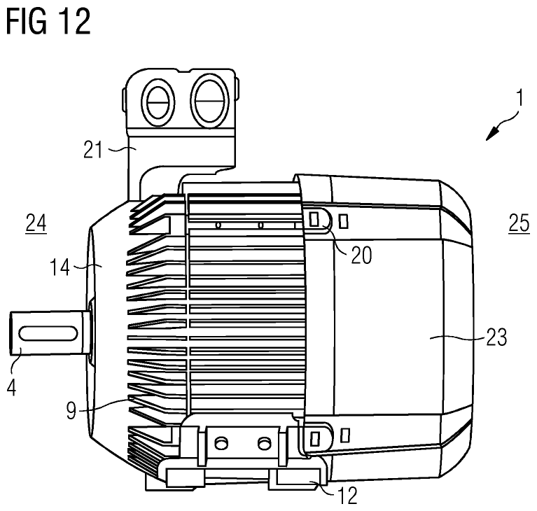

FIG. 12 is a side view of a dynamoelectric rotary machine,

It should be noted that terms such as “axial”, “radial”, “tangential”, etc. refer to the axis 6 that is used in the respective figure or in the example described in each case. In other words, the directions axial, radial, tangential always relate to an axis 6 of a rotor 3 and thus to the corresponding axis of symmetry of the stator 2. In this case, “axial” describes a direction parallel to the axis 6, “radial” describes a direction orthogonal to the axis 6, toward or away from it, and “tangential” is a direction which is directed circularly at a constant radial distance from the axis 6 and at a constant axial position around the axis 6. The expression “in the circumferential direction” should be equated with “tangential”.

With respect to a surface, for example a cross-sectional surface, the terms “axial”, “radial”, “tangential”, etc. describe the orientation of the normal vector of the surface, that is to say of that vector which is perpendicular to the affected surface.

The term “coaxial components”, for example coaxial components such as rotor 3 and stator 2, is here taken to mean components which have identical normal vectors, for which the planes defined by the coaxial components are therefore parallel to one another. Furthermore, the expression should include that the centers of coaxial components lie on the same axis of rotation or axis of symmetry. However, these center points can optionally lie on this axis possibly at different axial positions and said planes therefore have a spacing>0 from one another. The expression does not necessarily require that coaxial components have the same radius.

The term “complementary” means in connection with two components, which are “complementary” with respect to one another, that their outer shapes are embodied in such a way that the one component can preferably be arranged completely in the component complementary to it, so the inner surface of the one component and the outer surface of the other component ideally touch free of gaps or over the entire surface. Consequently, in the case of two mutually complementary objects, the outer shape of the one object is therefore defined by the outer shape of the other object. The term “complementary” could be replaced by the term “inverse”.

For the sake of clarity, often not all of the represented components are provided with reference characters in the Figures, in part in those cases in which components are present multiple times.

The described embodiments can be combined as desired. Similarly, individual features of the respective embodiments can also be combined without departing from the essence of the invention.

FIG. 1 shows a housing-free dynamoelectric rotary machine 1. This machine 1 comprises a stator 2, a rotor 3 and a shaft 4. The rotor 3 can be designed as a squirrel-cage rotor or permanently-excited rotor or as a reluctance rotor. The stator 2 is made of a magnetically conductive body of sintered material (as represented, for example, in FIG. 5) or of axially layered laminations (as represented, for example, in FIG. 4). Cooling ribs 9 are formed on an outer circumference of the stator 2, in particular on an outer circumference of the laminated core 8.

Bearing shields 14 are arranged on the end faces 17 of the stator 2.

FIG. 1 shows, moreover, that the bearing shield 14 also has cooling ribs. The bearing shield 14 also has at least parts of a connection box or terminal box base 21.

Furthermore, FIG. 1 shows add-on elements 12 which are embodied as supporting feet and whose mounting is described in the further figures.

By increasing the outer diameter on the stator 2 and the rotor 3, it is possible to make the machine 1 more compact power based on the axle height. In this case, the enveloping sizes are not larger than in the case of a machine with a housing.

Recycling and processing of motor components are simplified by this invention.

FIG. 2 shows a partial detail of a contour of a channel 16. The contour of the channel 16 has an opening 28 of jaws 15 arranged in the shape of pincers. A channel base 29 is located opposite the opening 28. The jaws form a channel structure 16 inwardly. Outwardly, the jaws 15 have a preferably flat section 18 which is formed after complementary surfaces of the add-on elements 12.

FIG. 3 shows a cross-section of the magnetically conductive body of the laminated core 8 of the stator 2. The laminated core 8 is constructed from axially layered laminations. Preferably, these individual laminations are adhesively bonded to one another over the entire surface. Four channel structures 16 are provided on the outer circumference of the stator 2. The number and/or the arrangement thereof can vary depending on the embodiment of the stator 2.

The individual laminations of the laminated core 8 are designed in one piece and thus have grooves for receiving a winding system (not shown in more detail), as well as cooling ribs 9 and the channel structures 16. The individual laminations are advantageously produced by punching. Cooling is thus integrated in the stator 2. A heat transfer from the heat sources of a stator 2 (winding system, iron losses, eddy current losses, etc.) during operation of a dynamoelectric rotary machine 1 to the cooling ribs 9 is thus optimal.

FIG. 4 shows a laminated core 8 of the stator 2 which is constructed from individual laminations which correspond in cross-section to FIG. 3. In this case, the axially continuous channels 16 are visible.

FIG. 5 shows a magnetically conductive, one-piece body of the stator 2 with its axially continuous channels 16.

FIG. 6 shows a perspective partial detail on the stator 2. Here, an add-on element 12 embodied as a supporting foot is fixed by two screws 11 and by means of a mounting element 10 located inside the channel 6. In this case, one or more mounting element(s) 19 is/are first inserted axially into the required channel 16 and the thread of the mounting element 10 is optionally aligned by a rotation.

At the intended axial position, the standing foot is then fixed via the two screws 11. The channel 16 is then covered by the cover 31 which may be part of the bearing shield 14.

The fixing is not shown in more detail in FIG. 7. One or more thread turn(s), preferably aligned in pairs, is/are provided in the mounting element 10, via which threads the add-on elements 12 are fixed to the stator 2. These threads in the mounting elements 10 are continuous, i.e. no blind holes. This makes it possible for screws 11 to pass through the mounting elements 10 into the channel base 29.

This improves the fixing and tensioning of the add-on elements 12 on the sections 18 of the jaws 15 and thus on the stator 2.

As represented in FIG. 9, the mounting elements 10 are preferably cylindrically shaped in order to be positioned in the channel 16, which is formed by the jaws 15, in a simple manner axially and/or by rotation.

As a result of the screwing-in process, the surface 19 of the add-on element 12 pulls the sections 18 against the complementary counterpart of the jaws 15.

In order to avoid a fanning out of the individual laminations at the prismatic contour of the jaws 15, the individual laminations of the stator 2 are adhesively bonded, stacked and bonded after punching or welded to one another over the entire surface or partially. In order to fix these laminations, in particular in the outer regions of the jaws 15, a weld seam 30 is preferably provided over the entire axial length of the laminated core 8. Laser welding is preferably used.

FIG. 8 shows a perspective partial view of an add-on element 12 embodied as a supporting foot on the stator 2.

FIG. 10 shows, in cross-section, the stator 2 with two supporting feet. Mounting elements 10 are inserted into the further two channels 16 in order to fix possibly further add-on elements 12, such as terminal boxes, converters, lifting lugs, etc.

FIG. 11 shows a bearing shield 14 which can be attached to an end face 17 of the laminated core 8 of the stator 2. It has cooling ribs, a circumferential gap 32, the cover 31 via the channels 16 and a terminal box base 21.

The stator 2 and the bearing shield 14 are sealed particularly well by an O-ring which is introduced into a gap 32. In this way, the machine 1 is particularly well protected against foreign bodies and contact as well as water. The machine 1 is thus suitable for the protection classes IP54 and IP55. A foamed seal can also be introduced into the gap 32.

An embodiment of a machine 1 with and without add-on elements 12 can thus be easily implemented, or can also be retrofitted. Machining required for this Is not necessary due to the existing accuracy from the punching process.

FIG. 12 shows the machine 1 with a hood 23. The machine 1 is preferably designed to be self-ventilated and advantageously has a fan (not represented). The hood 23 serves to shield this fan and the air guide.

This hood 23 is fixed to the stator 2 by means of a snap connection 20.

What is claimed is:.

1.-13. (canceled)

14. A housing-free dynamoelectric rotary machine, comprising:
a stator comprising a substantially hollow cylindrical magnetically conductive body which includes a plurality of jaws which are distributed on an outer circumference of the magnetically conductive body and arranged in a shape of pincers such that two of the jaws in opposite relation to one another form an axially extending channel structure;
a mounting element receivable in the channel structure and moveable axially and/or about its own axis in the channel structure;
an add-on element;
a connecting element designed to connect the mounting element to the add-on element in such a way that a complementary contact region of an outer section of the jaws and a corresponding surface of the add-on element result in at least one section to realize a wedge effect on the complementary contact region; and
a rotor mounted for rotation about an axis and spaced apart from the stator by an air gap.

15. The housing-free dynamoelectric rotary machine of claim 14, wherein the connecting element is a screw.

16. The housing-free dynamoelectric rotary machine of claim 14, wherein the mounting element has a round cross-section and includes a hole or a plurality of holes arranged in pairs.

17. The housing-free dynamoelectric rotary machine of claim 16, wherein the mounting element has a circular cross-section.

18. The housing-free dynamoelectric rotary machine of claim 14, further comprising an end element arranged on an axial end of the stator and mechanically connected to the stator by another connecting element.

19. The housing-free dynamoelectric rotary machine of claim 18, wherein the end element is a bearing shield.

20. The housing-free dynamoelectric rotary machine of claim 14, further comprising two or three of said mounting element received in the channel structure.

21. The housing-free dynamoelectric rotary machine of claim 14, wherein the add-on element is embodied as a foot, converter holder, holder for terminal boxes or as a holder of a monitoring apparatus.

22. The housing-free dynamoelectric rotary machine of claim 14, wherein the add-on element comprises at least one ribbed section.

23. The housing-free dynamoelectric rotary machine of claim 14, wherein the magnetically conductive body comprises cooling ribs which are oriented radially or in parallel at least in one section on an outer circumference of the stator.

24. The housing-free dynamoelectric rotary machine of claim 14, wherein the magnetically conductive body is constructed from laminations, each said lamination being designed in one piece and having the jaws and grooves for receiving a winding system, said laminations forming a laminated core of the stator in an axially layered manner, with the axially extending channel structure being formed on the laminated core.

25. The housing-free dynamoelectric rotary machine of claim 19, wherein the bearing shield axially covers the axially extending channel structure at least in one section.

26. The housing-free dynamoelectric rotary machine of claim 18, wherein the end element comprises part of a terminal box which supplies the dynamoelectric rotary machine with electrical energy.

27. The housing-free dynamoelectric rotary machine of claim 14, wherein the stator comprises at least one section with a coating.

28. The housing-free dynamoelectric rotary machine of claim 27, wherein, the coating is a metallic coating.

29. The housing-free dynamoelectric rotary machine of claim 14 for use as a drive for a compactor, pump, compressor, or fan in an industrial environment, in food industry or in a traction application.
